(19) United States
(12) Patent Application Publication
(10) Pub. No.: US 2004/0194648 A1
(43) Pub. Date: Oct. 7, 2004

(54) Nail art performing device

(76) Inventor: Kazutsugu Uchida, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/742,765

(22) Filed: Dec. 23, 2003

(30) Foreign Application Priority Data
Dec. 5, 2003 (JP) 2003-407258
Dec. 27, 2002 (JP) 2002-381282

(51) Int. Cl. B41F 17/00

(52) U.S. Cl. 101/35

(57) ABSTRACT

A nail art performing device includes a fingertip fixing part for fixing a finger to which nail art is to be performed, a plate feeding mechanism for feeding a plate board, an ink nozzle accumulating portion for dropping ink in the vicinity of a printing plate to be used on the plate board that is transferred by the plate feeding mechanism, a squeegee for applying the dropped ink onto the printing plate, a pad for reapplying, after transfer of applied ink, the transferred ink to the nail of a person to be treated for performing printing, and a printing plate washing unit for washing the plate board after use. The device enables accurate, quick painting of images of various contents on nails using ink of various colors without requiring troublesome operations of the user and with relatively little staining of the periphery of the device.

### BACKGROUND OF THE INVENTION

1. Field of the Invention

The present invention relates to a nail art performing device, and particularly to a nail art performing device with which it is possible to print various patterns, figures or letters in multiple colors onto nail surfaces of users and is thus applicable in fields of cosmetics and amusement.

2. Description of the Prior Art

Nail art performing in which patterns, figures or letters are painted in multiple colors on surfaces of nails is being actively performed in these years especially among young girls accompanying improvements in standards of living of consumption, and it is widely taking root as a style of cosmetic fashion rather than being a temporal boom.

However, nail art performing is currently a professional service that is provided in beauty shops, and drawbacks were presented in that the number of nailists for performing the nail art was insufficient, in that it took time until completion, and in that costs thereof would sometimes be extremely high accordingly.

For solving those drawbacks, some suggestions have been made in these days in which nail art images were printed onto nails for the purpose of solving those problems.

The inventors have suggested a method for performing nail art in which a stencil is placed onto a nail to be closely adhering thereto whereupon ink is jetted thereon (see Patent Reference 1).

There are also suggested a device in which colored ink is jetted onto a nail portion by using an ink jet printer along an image pattern that is stored in a memory portion such as a memory card for printing a nail art image (see, for instance, Patent Reference 2) and a device capable of vividly printing patterns upon recognizing contours and shapes of nail portions (see, for instance, Patent Reference 3).

Patent Reference 1: Japanese Patent Laid-Open Publication No. 2001-314226 (Pages 3 to 8, FIG. 1)

Patent Reference 2: Japanese Patent Laid-Open Publication No. 2002-165632 (Pages 2 to 4, FIG. 1)

Patent Reference 3: Japanese Patent Laid-Open Publication No. 2000-194838 (Pages 2 to 5, FIG. 1)

However, conventional printing methods of nail art were based on ink jet methods employing ink jet printers or similar. In such ink jet methods, it is necessary that a jetting direction of ink is perpendicular to a surface to be printed. Such a method is therefore not necessarily suitable for printing on an object to be printed such as a nail that is basically curved, and drawbacks were presented in that the printing tended to be blurred at warped portions at peripheries of nails so that methods needed to be contrived for performing vivid printing, and even the method as disclosed in Patent Reference 3 was not necessarily a sufficient measure. Another problem was it that the periphery of a base on which the fingertip is placed was easily stained when ink came off contours of nails in the ink jet method, and it was therefore not very favorable in view of appearance for a nail art printing device that is frequently used by the public.

Incidentally, a pad printing device is known as a device for printing images such as letters or designs. A pad printing device is arranged in that ink is applied on a printing plate formed with concave portions in accordance with an image to be printed, and in that the ink that has been made to flow into the concave portions is transferred onto an object to be printed by using an elastic medium for ink transfer that is referred to as a pad for performing printing. By using such a pad, a pad printing device is arranged in that it is capable of performing printing not only on flat surfaces but also on curved surfaces, in that it is possible to print delicate designs, and in that it is possible to print on soft objects (such as fruits or sweets) or fragile objects (such as eggs, pottery or glassware).

### SUMMARY OF THE INVENTION

It is an object of the present invention to provide a nail art performing method and a nail art performing device with which it is possible to paint images of various contents on nails by using ink of various colors in a quick and accurate manner without requiring any troublesome operations of the user and that relatively less stains the periphery of the device by utilizing the features of pad printing method.

For achieving the above subjects, the nail art performing device according to one aspect of the present invention is a nail art performing device for applying ink onto a printing plate formed with concave portions, transferring the ink present on the concave portions of the printing plate onto a pad, and retransferring the ink that has been transferred onto the pad onto a nail, the nail art performing device comprising a fingertip fixing means that fixes a fingertip of a person to be treated, a printing plate selecting means that selects a printing plate to be used from among a plurality of those printing plates, a printing plate transferring means that linearly transfers a printing plate that has been selected by the printing plate selecting means on an operation plane, an ink dropping means that selects one of those inks introduced from a plurality of ink containers accumulating therein the inks and dropping the selected ink in vicinity of the printing plate being transferred by the printing plate transferring means, an ink applying means that applies the ink that has been dropped in vicinity of the printing plate by the ink dropping means onto the printing plate, and a printing means that, after transfer of the ink applied onto the printing plate by the ink applying means to the pad, makes the pad contact a nail of the fingertip of the person to be treated that is fixed by the fingertip fixing means for retransfer and to thereby perform printing on the nail.

With this arrangement, it is possible to realize a nail art performing device in which images of various contents can be painted on a nail of a person to be treated by using ink of various colors in a quick and accurate manner without requiring any troublesome operations of the operator.

The fingertip fixing means is arranged in that it is provided with a nail position designating means that determines a position of the nail of the person to be treated.

With this arrangement, it is possible to realize a nail art performing device in which the position of the nail can be accurately determined and in which an image can be accurately painted onto the nail.

The nail art performing device is arranged in that a printing plate receiving position at which the printing plate transferring means receives the printing plate, an ink drop operation position at which the ink is dropped onto the printing plate, a transfer operation position at which the dropped ink is applied onto the printing plate and the applied ink is transferred onto the pad, a printing plate washing position at which the printing plate is washed after completion of the transfer operation, and a printing plate drying position at which the washed printing plate is dried are aligned on the operation plane in this order, wherein the printing plate transferring means transfers the printing plate in this order between the respective positions.

With this arrangement, the printing plate may pass through a series of operations by being moved linearly on this operation plane, and it is possible to realize targeted operations by moving the printing plate through a relatively simple transferring method.

The nail art performing device is arranged in that it further comprises a medium mounting means capable of mounting a plurality of printing plate-bearing media, which are media formed with at least one of the printing plates, and a medium pick-up means that picks up one of the printing plate-bearing media mounted on the medium mounting means, wherein the printing plate transferring means transfers the printing plate-bearing medium that has been picked up by the medium pick-up means and wherein the ink dropping means drops one of those inks selected and introduced from the ink containers in vicinity of the printing plate being transferred by the printing plate transferring means.

With this arrangement, it is possible to realize a nail art performing device of relatively simple arrangement in which the printing plate transferring means may be provided with a function of selecting ink, in which images can be widely and freely selected from among a plurality of printing plates on a plurality of printing plate-bearing media, in which ink of various colors can be selected from among a plurality of ink containers, and in which a variety of nail art patterns may be painted.

The nail art performing device is arranged in that when the medium pick-means has picked up a printing plate-bearing medium formed with a plurality of printing plates, printing to the nail is repeatedly performed while changing the printing plates of the picked up printing plate-bearing medium that are used for printing as needed.

With this arrangement, it is possible to realize a nail art performing device in which images can be widely and freely selected from among a plurality of printing plates on a plurality of printing plate-bearing media and in which a variety of nail art patterns may be painted.

The nail art performing device is arranged in that the ink that has been dropped by the ink dropping means with respect to the printing plate-bearing medium that is transferred by the printing plate transferring means is applied by a squeegee that comprises the ink applying means.

With this arrangement, it is possible to realize a nail art performing device in which dropped ink is spread on the printing plate while excessive ink is removed so that nail art patterns free of contour bleeds can be painted.

The nail art performing device is arranged in that it further comprises a pad cleaning means for cleaning the pad.

With this arrangement, it is possible to realize a nail art performing device in which staining of the pad is prevented and in which nail art patterns of clear colors can be painted without mixing of colors.

The nail art performing device is arranged in that it further comprises a printing plate washing means for washing the printing plate.

With this arrangement, it is possible to realize a nail art performing device in which printing plates are washed each time they are used and in which nail art patterns can be painted with colors free of stains.

The nail art performing device according to another aspect of the present invention is a nail art performing device for applying ink onto a printing plate formed with concave portions, transferring the ink present on the concave portions of the printing plate onto a pad, and retransferring the ink that has been transferred onto the pad onto a nail, the nail art performing device comprising a fingertip fixing means that fixes a fingertip of a person to be treated, an ink applying means that applies the ink that has been dropped in vicinity of the printing plate by the ink dropping means on the concave portion of the printing surface, a pad cleaning means that cleans the pad, a pad moving means that moves the pad among respective operation positions on the ink applying means, on the pad cleaning means and on the fingertip fixing means, a pad elevating means that moves the pad up and down, that transfers ink to the pad on the ink applying means, that retransfers ink that has been transferred to the pad upon making it contact a nail of the fingertip of the person to be treated that is fixed on the fingertip fixing means, and that cleans residing ink or foreign matters adhering to the pad on the pad cleaning means.

With this arrangement, it is possible to realize a nail art device of simplified type in which it is possible to perform selection of a printing plate, selection of ink to be applied to the printing plate, and dropping of ink in a manual manner and in which images of various contents can be painted onto nails of a person to be treated at favorable accuracy using ink of various colors.

The fingertip fixing means is arranged in that it is provided with a nail position designating means that determines a position of the nail of the person to be treated.

With this arrangement, it is possible to realize a nail art device of simplified type in which the position of the nail can be accurately determined and in which an image can be accurately painted onto the nail.

The nail art performing device is arranged in that the operation positions are located on a circumference, and wherein the pad moving means moves the pad on this circumference.

With this arrangement, it is possible to realize a nail art device of simplified type in which moving of the pad is simplified and in which major operations can be performed by this moving of the pad.

The nail art performing device is arranged in that the operation positions are located on a straight line, and wherein the pad moving means moves the pad on this straight line.

With this arrangement, it is possible to realize a relatively small and simple nail art device of in which moving of the pad is performed in a linear manner and in which major operations can be performed by this moving of the pad.

The nail art performing device is arranged in that it further comprises a printing plate washing means for washing the printing plate.

With this arrangement, it is possible to realize a nail art device of simplified type in which printing plates are washed each time they are used and in which nail art patterns can be painted with colors free of stains.

The nail art performing device is arranged in that the printing plate washing means includes a washing liquid absorbing means that absorbs washing liquid with which the printing plate has been washed.

With this arrangement, it is possible to realize a nail art device of simplified type in which processes after washing can be easily performed, in which drying of the printing plates can be omitted, and which is free of fear of staining the periphery thereof.

### BRIEF EXPLANATION OF THE DRAWINGS

FIG. 1 is a plan view of the nail art performing device according to a first embodiment of the present invention.

FIG. 2 is a side view of the nail art performing device according to the first embodiment.

FIG. 3 is an explanatory view illustrating an arrangement of a fingertip fixing means according to the first embodiment.

FIG. 4 is an explanatory view for illustrating examples of printing plates on plate boards of the present invention.

FIG. 5 is an explanatory view illustrating an arrangement of a pad cleaning device according to the first embodiment.

FIG. 6 is a block diagram of a circuit of the nail art performing device according to the first embodiment.

FIG. 7 is a plan view of the nail art performing device according to a second embodiment of the present invention.

FIG. 8 is a side view of the nail art performing device according to the second embodiment.

FIG. 9 is a side view of the nail art performing device according to a third embodiment of the present invention.

FIG. 10 is a front view of the nail art performing device according to the third embodiment.

### DESCRIPTION OF THE PREFERRED EMBODIMENTS

Embodiments of the present invention will now be explained in details with reference to the drawings.

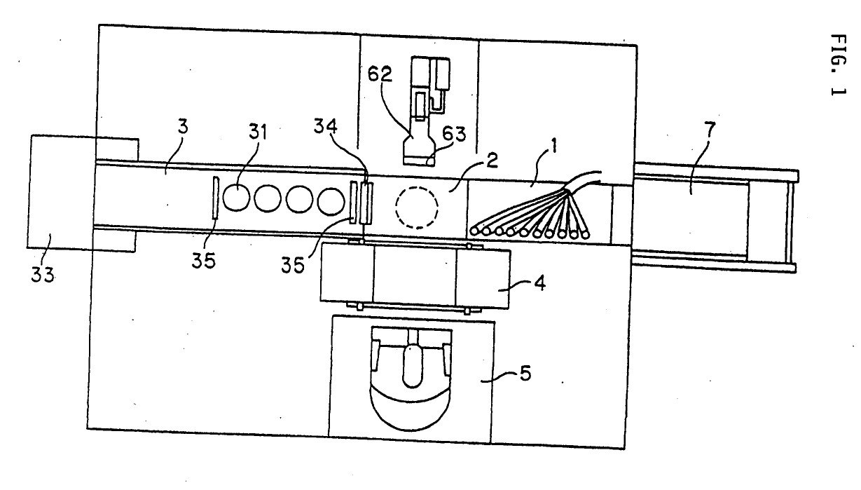

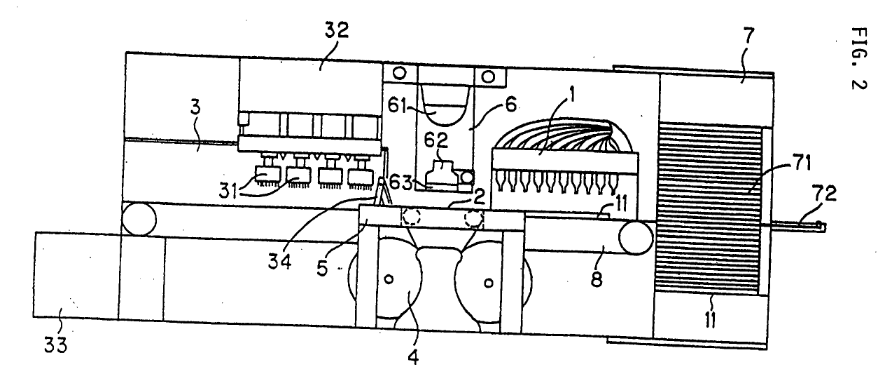

FIG. 1 illustrates a planar block view of the nail art performing device according to a first embodiment of the present invention, and FIG. 2 illustrates a side block view thereof. In FIGS. 1 and 2, reference numeral 1 denotes an ink nozzle accumulating portion, reference 2 a transfer operation stage, reference number 3 a printing plate washing unit, reference number 4 a pad cleaning device, reference number 5 a fingertip fixing means, reference number 6 a pad/squeegee unit, reference number 7 a plate stocker/changer, reference number 8 a plate feeding mechanism, and 11 plate boards. The nail art performing device of this embodiment illustrates one example that is of relatively small size and one of a type that is used for commercial use in beauty shops or similar.

The nail art performing device of the present embodiment is provided with the fingertip fixing means 5 in the front thereof, and through operations of a control panel (not shown), nail art is performed to a nail of a finger that is set on the fingertip fixing means 5.

Operations of the nail art performing device according to the present embodiment will now be explained in the order of events.

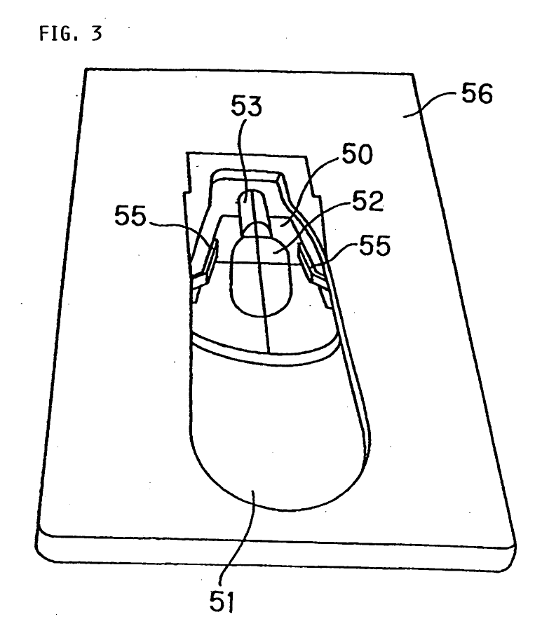

Functions of the fingertip fixing means 5 will first be explained. In FIG. 3, the fingertip fixing means 5 is comprised of a fingertip mounting base 52 and a nail tip mounting portion 53 that can be moved back and forth, a finger pincher 55 for pinching and fixing the fingertip during operations, a table 56, and a wrist inserting hole 51 provided to enable insertion of a wrist upward from below the table 56 for fixing a finger on the fingertip mounting base 52.

Explaining operations of the fingertip fixing means 5, a person to be treated inserts his or her hand through the wrist inserting hole 51, mounts a finger that is object of treatment on the fingertip mounting base 52, and further mounts its nail tip on the nail tip mounting portion 53. In this condition, the fingertip mounting base 52 is moved back and forth such that an indication of a nail center coincides with a longitudinal center of the nail and that an indication line of a nail rear end coincides with a boundary of a cuticle at the rear end of the nail. In this manner, the nail can be placed to an optimal printing position.

When a set completion button is pressed in this state through the control panel (not shown) for inputting completion of setting, the finger pincher 55 closes for holding the fingertip from the right and left so as to fix the fingertip. By closing the finger pincher 55, the approximate width of the nail is input to the device so that nail art printing to the nail is started. Upon completion of printing of a designated picture or design, the finger pincher 55 opens to release the finger.

The method for performing nail art printing according to the present embodiment will now be explained.

The plate stocker/changer 7 of FIGS. 1 and 2 includes a rack-like holder 71 for mounting plate-like printing plate-bearing media (hereinafter referred to as “plate boards”) 11, which hold a plurality of printing plates 12 formed with concave portions in accordance with images, thereon. The holder 71 is arranged in that a plurality of plate boards 11 may be mounted in a vertically overlapped at specified intervals. The plate stocker/changer 7 is provided with an elevating mechanism (not shown) for moving the holder 71 up and down and a plate pushing mechanism 72 for pushing the plates 11 out from the holder 71, wherein a selected plate board 11 is pushed out by the plate pushing mechanism 72 by the up and down movement of the elevating mechanism and is mounted on the plate feeding mechanism 8.

When the plate board 11 is mounted thereon, the plate feeding mechanism 8 starts moving for feeding the plate board 11 in a left-hand side direction in the drawing. In the course of feeding, the plate board 11 passes below the ink nozzle accumulating portion 1. At a point of time at which a position of the printing plate 12 on the plate board 11 coincides with a nozzle position of ink of a color that is to be applied onto the printing plate 12, air is sent to the ink nozzle through control of a control device (not shown), and the ink is dropped in vicinity of a design of the printing plate 12 that is closer to the fingertip fixing means 5. Where a plurality of printing plates 12 existing on the same plate board 11 is used, inks of a color that is to be applied to the respective printing plats 12 are dropped in vicinity of the respective designs of the plurality of printing plates 12. A plurality of ink nozzles is loaded in a line on the ink nozzle accumulating portion 11 that is connected to ink containers (not shown) that contain therein ink. Here, the inks are, for instance, water-soluble.

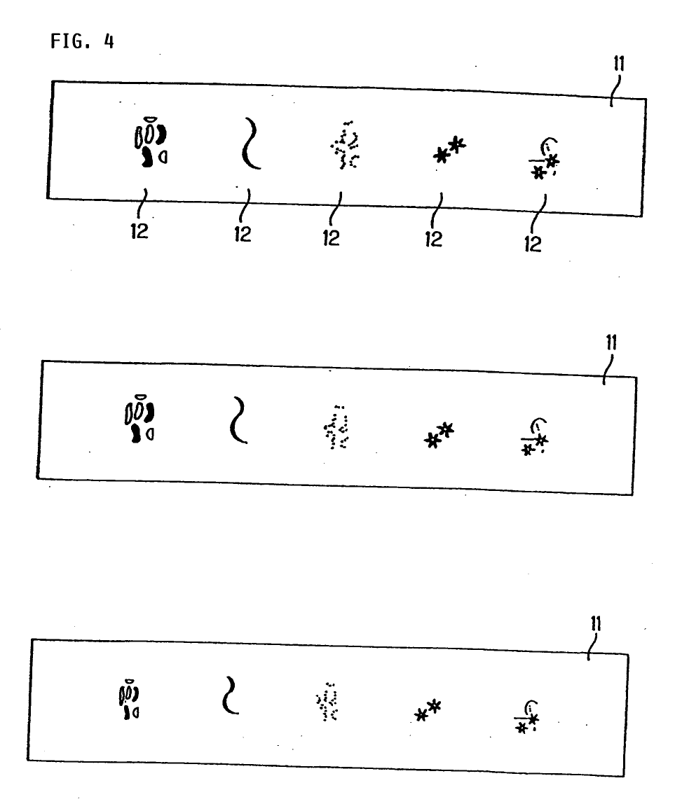

FIG. 4 illustrates an example of the printing plates 12 provided on the plate board 11. As illustrated in FIG. 4, a plurality of printing plates 12 is formed on the plate board 11 in a line. A printing plate 12 that is used for printing is sequentially selected depending on a position of the moving direction. It is preferable that a plurality of printing plates 12 is provided also for the same patterns so as to correspond to widths and lengths of fingers as illustrated in FIG. 4. It is desirable to provide a suitable stopping mechanism on a lower surface of the plate board 11 so that it can be stably positioned on the plate feeding mechanism 8.

After dropping of ink, the plate feeding mechanism 8 moves the plate board 11 further leftward for positioning a printing plate 12 on the transfer operation stage 2.

Since the present embodiment is arranged in that ink that is to be applied to the printing plate 12 is automatically selected and changed in accordance with designations from the control panel, it is not necessary to perform any additional particular operations once the printing plates 12 and inks to be applied thereon are selected when utilizing the nail art performing device. It is accordingly possible to perform easy nail art printing of images of various contents to nails of interest.

Upon completion of dropping ink, the plate feeding mechanism 8 stops the plate board 11 such that a printing plate 12 to be transferred is located in a center of the transfer operation stage 2 during transfer operations. The transfer operations are performed in accordance with the following processes.

Printing is performed by the pad/squeegee unit 6 for moving a pad 61 and a squeegee 62 in a perpendicular direction with respect to a moving direction of the plate feeding mechanism 8 through an identical moving mechanism, and for respectively moving the pad 61 and the squeegee 62 in vertical directions.

When the printing plate 12 is fitted at a specified position, the pad/squeegee unit 6 moves downward from a halting position, which is above the pad cleaning device 4 located between the fingertip fixing means 5 and the transfer operation stage 2, and the squeegee 62 performs operations of scratching over the printing plate 12 from this position for spreading and filling in the ink dropped in vicinity of a design on the printing plate 12 and of scraping off excessive ink.

The squeegee 62 is provided with a moving cylinder (not shown) for moving the squeegee 62 in horizontal directions, an angle adjusting cylinder, and a blade 63 for removing excessive ink from above the printing plate 12. The angle adjusting cylinder adjusts an angle of the blade 63 or a position thereof in vertical directions. When the angle adjusting cylinder is driven, a shaft supporting the blade 63 is pushed out so that the blade 63 rotates around a fulcrum to contact the plate board 11. The squeegee 62 moves the blade 63 from a side closer to the fingertip fixing means 5 to the opposite side of the printing plate 12 through the moving cylinder. With this arrangement, filling in of ink dropped in vicinity of the printing plate 12 to the printing surface 12 and scraping off of excessive ink from the printing surface 12 is performed.

Upon completion of these operations, the blade 63 is cleaned upon scraping off adhering ink from both surfaces, each by each, through a cleaning blade (not shown). The squeegee 62 is thus always ready to operate by maintaining both surfaces thereof in cleaned conditions.

After removal of excessive ink from the printing plate 12 through the squeegee 62 in the above-described manner, the pad/squeegee unit 6 performs printing to the nail by using the pad 61.

The pad 61 is moved up and down by means of an elevating cylinder (not shown) for performing printing. At a point of time application of ink by the squeegee 62 has been completed, the pad 61 is located above the transfer operation stage 2, which is a pad depressing position.

By driving the elevating cylinder for a preliminarily set time at this position, the pad 61 is moved up and down such that the pad 61 contacts the printing plate 12 for transferring the ink remaining at concave portions of the printing plate 12 to the pad 61.

After transfer of the ink of the printing plate 12 to the pad 61, the moving cylinder moves the pad 61 to above the fingertip fixing means 5. By repeatedly driving the elevating cylinder for a preliminarily set time above the fingertip fixing means 5, the pad 61 is repeatedly moved up and down. With this arrangement, ink transferred to the pad 61 can be retransferred to the nail mounted on the fingertip fixing means 5 to perform printing. After completion of printing to the nail in the above-described manner, the moving cylinder repeatedly moves the pad 61 to above the pad cleaning device 4 to return the same to the ordinary position.

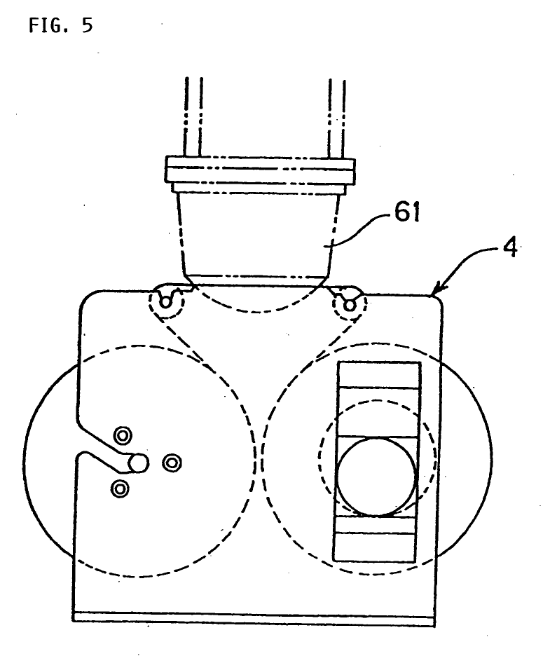

The pad cleaning device 4 is for removing foreign matters, dirt and dust adhering to the pad 61 or ink remaining on the pad 61. As illustrated in FIG. 5, rollers to which motive energy of the motor is transmitted are used for winding up a tape that has been drawn out from a roll of tape in which an adhesive tape is wound. A part of the tape drawn out from the roll of tape faces its adhesive side upward to be exposed upward. With this arrangement, when the pad 61 is moved up and down in a condition in which it is positioned above the pad cleaning device 4, the surface of the pad 61 contacts with the adhesive surface of the tape to thereby remove foreign matters adhering to this surface or remaining ink through the adhesiveness of the tape.

In this respect, cleaning of the pad 61 employing the pad cleaning device 4 is performed at preliminarily determined timings. Such timings are, for instance, at times of switching the power ON, after completion of printing or after completion of printing for a specified number of times, and upon particular instructions by an operator.

By providing a pad cleaning device 4 for performing cleaning of the pad 61, cleaning of the pad 61 can be automatically performed so that the present device can be automatically driven for a long period of time without performing any particular maintenance.

In this respect, a plate board 11 that has been used is cleaned by the washing unit 3. After transfer of the ink from the printing plate 12 by the pad 61, the plate feeding mechanism 8 moves the plate board 11 further inward of the cleaning unit 3 in a direction on the left-hand side of the drawing. The cleaning unit 3 is comprised of a plurality of brushes 31, a motor (not shown) for rotating the brushes 31, a cylinder (not shown) for moving the brushes 31 up and down, a washing liquid tank 32 for supplying washing water to the brushes 31, a waste liquid tank 33 for collecting the waste liquid after washing, a scraper unit 34 for scraping off moisture or ink stains remaining and adhering to the plate board 11, and an air blower device 35 for blowing off moisture remaining on the plate board 11. At the point of time printing to a nail mounted on the fingertip fixing means 5 by the pad 61 is being executed, washing water is poured to the plate board 11 from the washing liquid tank 32, and through rotation of the brushes 31 of the washing unit 3 on the plate board 11, excessive ink remaining on the plate board 11 can be cleaned. By further scraping the plate board 11 that has been washed by the brushes 31 by the scraper unit 34, remaining moisture and dust or similar can be scraped off, and remaining moisture is further blown off and removed by the air blower device 35.

The plate board 11 that has been cleaned by the washing unit 3 can be either sent back by the plate feeding mechanism 8 in a reverse direction to the holder 71 or sent out of the device through a suitable method.

Printing of art patters to nails of a person to be treated by the above-described arrangement is performed, as a whole, in the following manner.

First of all, a person to be treated, who is the user, selects pictures or patterns and colors of an art pattern to be printed onto the nail from among samples of nail art patterns. Upon determination of contents to be printed, a number of a plate board 11 at which the art pattern is provided, a position of the printing plate 12 and a color number is input from the control panel. A plate board 11 including the designated art pattern is designated from among the plate boards 11 placed in the holder 71 for sending the same out to the plate feeding mechanism 8. When the plate board 11 is placed on the plate feeding mechanism 8, the plate feeding mechanism 8 works to move the plate board 11 to pass below the ink nozzle accumulating portion. At this time, when the printing plate 12 out of the plate board 11 that is employed for printing has reached below the nozzle of a selected color, ink is dropped in vicinity of the printing plate 12 in question. Feeding of the plate board 11 is continued by the plate feeding mechanism 8 also after dropping of ink such that the printing plate 12 is placed in the center of the transfer operation stage 2. At this position, the squeegee 62 performs application of ink onto the printing plate 12 and removal of excessive ink, and thereafter, ink of the printing plate 12 is transferred onto a nail through the pad 61 for performing printing. After completion of printing, the plate board 11 is washed and dried in the washing unit 3, and the pad 61 is also cleaned. The plate board 11 is then returned to the holder 71, and a printing plate 12 that is used in the following printing process is selected to perform the following printing process in a similar manner. By repeating these processes, targeted printing is performed.

In this respect, in case ink has run over the nail to adhere to a part of the finger, it is possible to wipe such ink off by using a cleaning cotton swab dipped with water. After completion of nail art performing, it is possible to prevent the ink from coming off by applying top coating onto the nails.

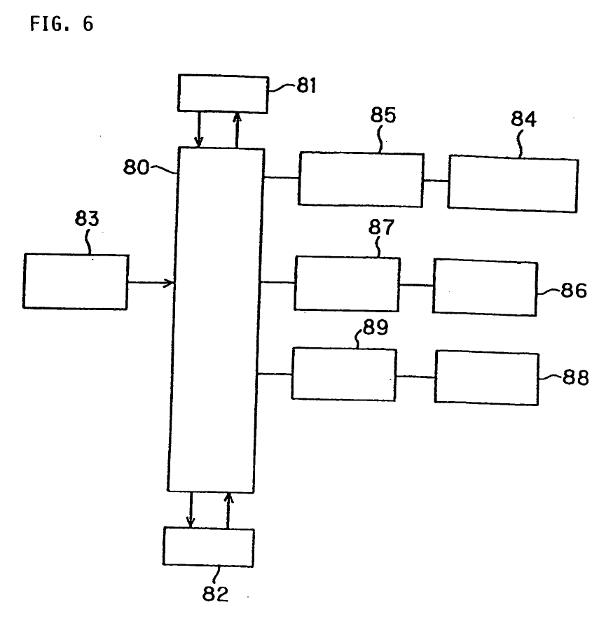

FIG. 6 is a structural diagram of a circuit of the nail art performing device according to the present embodiment.

The present embodiment is comprised, as illustrated in FIG. 6, with a CPU 80 for performing control of the entire device, a ROM 81 storing therein programs or various control data, a RAM 82 that the CPU 80 uses for working, a control panel 83 that serves as an input device for the user for performing various instructions, a group of cylinders 84 collectively representing the above-described various cylinders and solenoid valves for driving the same, a cylinder driving portion 85 for driving the group of cylinders 84, a group of motors 86 collectively representing the above-described various motors, a motor driving portion 87 for driving the various motors comprising the group of motors 86, a group of sensor 88 collectively representing various sensors, and a sensor driving portion 89 for driving the various sensors comprising the group of sensors 88 and monitoring outputs thereof.

In this respect, a motor for an air-compressor for blowing in air into the ink containers is also included in the motors comprising the group of motors 86. All of the above-described various cylinders may, for instance, be an air cylinders that are driven through solenoid valves.

The CPU 80 controls the cylinder driving portion 85 and the motor driving portion 87 in accordance with instructions that have been made by the user through the control panel 83 while observing output signals of the various sensors that are sent from the sensor driving portion 89. With this arrangement, the above-described operations are realized.

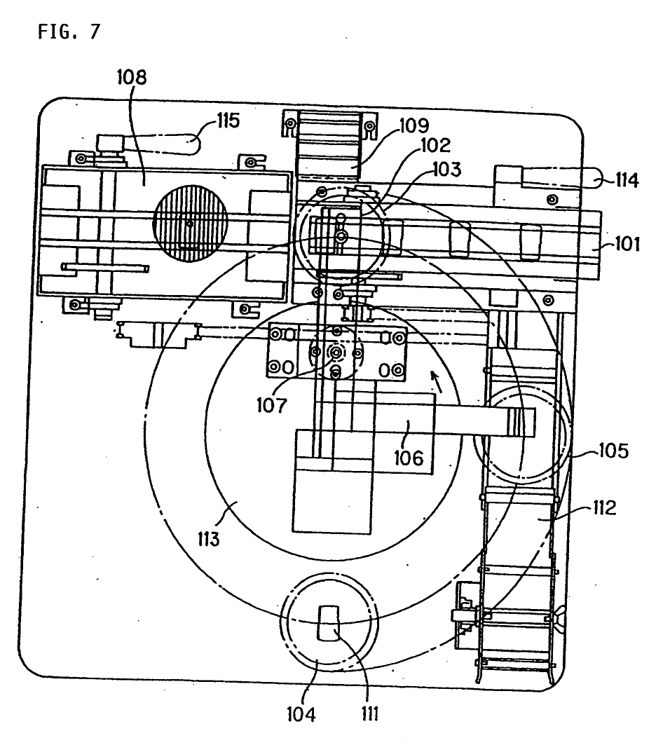

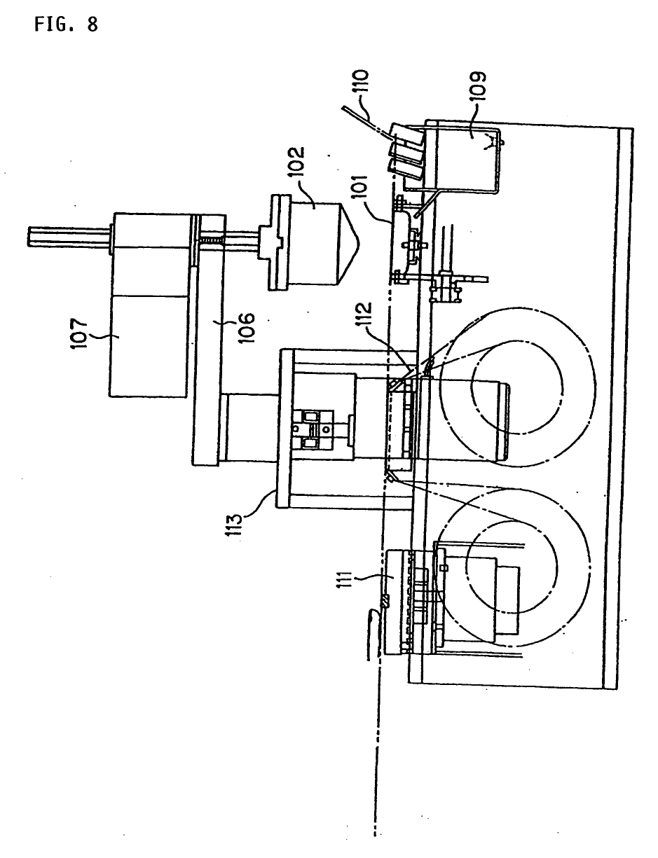

FIG. 7 illustrates a plan view of a second embodiment of the present invention and FIG. 8 a side view thereof. This embodiment is one of a simplified and small-sized form, wherein selection of printing plates or dropping of ink to the printing plates is performed in a manual manner.

In FIGS. 7 and 8, reference numeral 101 denotes a plate board mounting base, reference numeral 102 a pad, reference numeral 103 an ink applying position, reference numeral 104 a nail art printing position, reference numeral 105 a pad cleaning position, reference numeral 106 a pad arm, reference numeral 107 a linear motor, reference numeral 108 a plate board washing portion, reference numeral 109 a squeegee tank, reference numeral 110 a squeegee, reference numeral 111 a fingertip fixing means, reference numeral 112 a pad cleaning device, reference numeral 113 a turntable, and reference numerals 114 and 115 chuck handles.

For use, a plate board 11 is selected and is mounted on the plate board mounting base 101. The plate board 11 may be one as illustrated in FIG. 4. A printing plate 12 of the plate board 11 is selected, and ink to be applied to the printing plate 12 is also selected and dropped in vicinity of the printing plate 12. The plate board 11 is fixed by the chuck handle 114 such that a printing plate 12 of a pattern to be printed is located at the ink applying position 103, and the squeegee 110 is moved on the plate board 11 such that ink is spread and filled into the printing plate 12 while excessive ink is scraped off. When ink is successively applied onto the printing plate 12, the printing plate 12 is set at the ink applying position 103, and the person to be treated fixes a finger to which nail art is to be performed on the fingertip fixing means 111. When an operating switch (not shown) is pressed in this state, nail art printing operations are started. The squeegee tank 109 of FIG. 7 is for cleaning the squeegee 110 after the operation. The ink is supposed to be water-soluble.

When nail art printing is started, the pad 102 is descended at the ink applying position 103 to the plate board 11 applied with ink through the action of the linear motor 107. The ink applied on the printing plate 12 is thereby transferred to the pad 102. Upon completion of transfer of ink to the pad 102, the linear motor 107 raises the pad 102 upward.

When the pad 102 is raised up after transfer of ink at the ink applying position 103, the turntable 113 rotates by 180° in a clockwise direction for moving the pad 102 to the nail art printing position 104. When the pad 102 is descended at this position by the action of the linear motor 107, ink transferred onto the pad 102 is retransferred onto a nail of a person to be treated so as to perform nail art printing, and the pad 102 is drawn up.

Upon completion of nail art printing, the pad 102 is again raised by the action of the linear motor 107, and the turntable 113 rotates by 90° in a counterclockwise direction so as to move the pad 102 to the pad cleaning position 105. At this position, the pad 102 is descended by the action of the linear motor 107, and the pad 102 contacts an adhesive tape surface of the pad cleaning device 112. The pad cleaning device 112 is for removing foreign matters, dirt and dust adhering to the pad 102 or ink remaining on the pad 102, and is arranged similar to that as illustrated in FIG. 5. For simplification, the present embodiment is arranged in that winding of the tape is performed manually after each use. Upon contact of the surface of the pad 102 with the adhesive surface of the tape, foreign matters adhering to the surface or remaining ink is removed by being adhered to the adhesive surface of the tape.

Upon completion of cleaning of the pad 102, the pad 102 is again raised by the action of the linear motor 107 and the turntable 113 rotates by another 90° in a counterclockwise direction so as to move the pad 102 to the ink applying position 103 and to stop it thereat.

By such a series of operations, a pattern of a selected printing plate 12 is nail art printed onto a finger of a person to be treated. Upon repeating nail art printing by selecting plate boards 11 and printing plates 12, it is further possible to print more complicated patterns.

After completion of operations, the plate board 11 is fixed on the plate board washing portion 108 by the chuck handle 115 to be washed and dried.

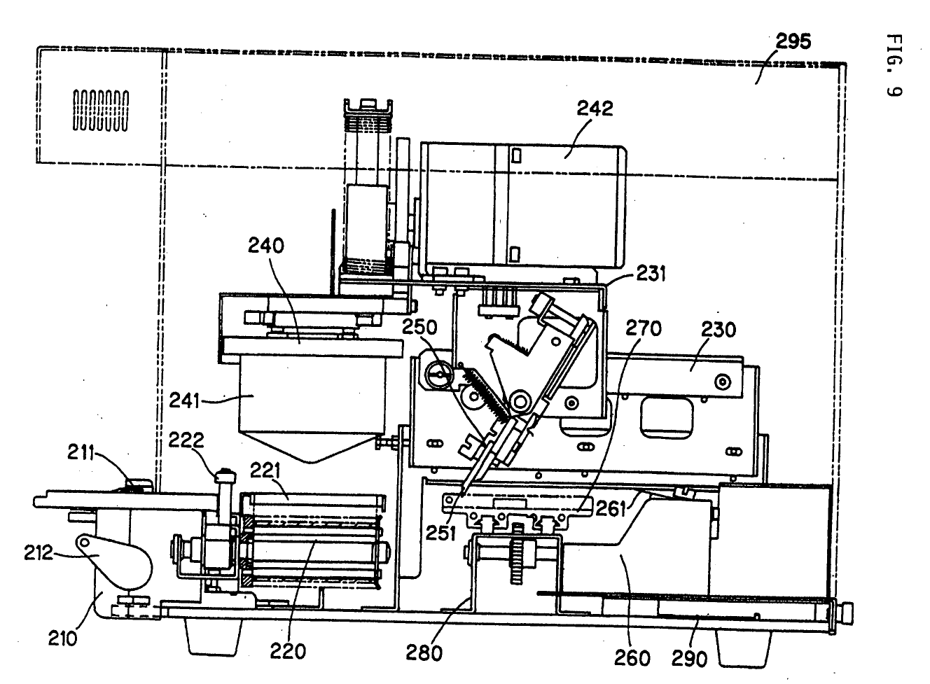

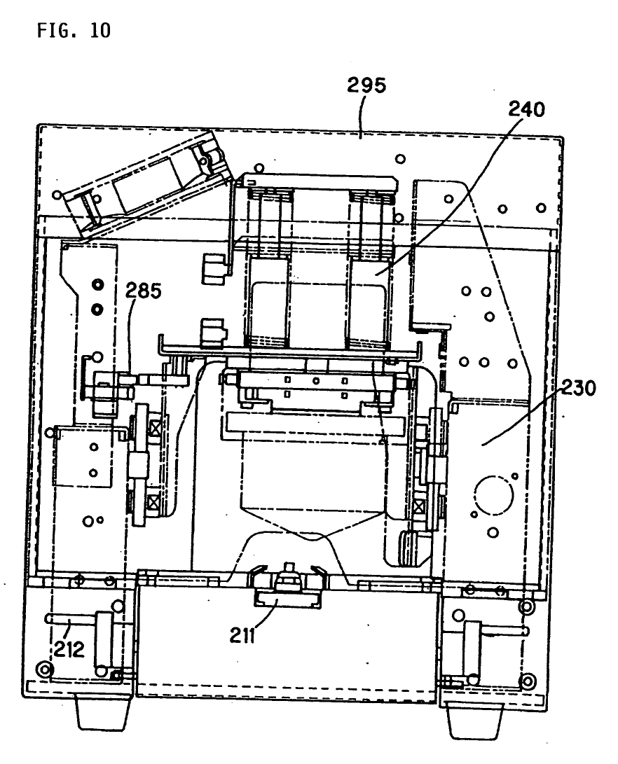

FIG. 9 illustrates a side view of a third embodiment of the present invention, and FIG. 10 a front view thereof. This embodiment is one of a simplified and small-sized form in which selection of printing plates or dropping of ink to the printing plates is performed in a manual manner, similar to the second embodiment as illustrated in FIGS. 7 and 8, wherein a moving direction of the pad is linear with respect to a person to be treated. In FIGS. 9 and 10, reference numeral 210 denotes a finger mounting base, reference numeral 220 a pad cleaner, reference numeral 230 a pad back and forth moving unit, reference numeral 240 a pad up and down moving unit, reference numeral 250 a squeegee unit, reference numeral 260 a squeegee cleaner, reference numeral 270 a plate board tray, reference numeral 280 a tray sending unit, reference numeral 290 a counter and reference numeral 295 a device cover.

Similar to the second embodiment, a nail art pattern is first selected from a plurality of printing plates 12 of a plurality of plate boards 11 for use. The printing plates 11 may be those as illustrated in FIG. 4. First of all, a plate board 11 including a design to be used is mounted onto the plate board tray 270. Note, however, that the plate board 11 of the present embodiment is arranged in that a plurality of printing plates 12 is etched on a tempered glass, wherein four printing plates 12 are provided on a signal plate board 11. Upon selecting a printing plate 12, ink applied to this printing plate 12 is also selected and dropped in vicinity of the printing plate 12. The ink is water-soluble ink. The plate board tray 270 is moved manually such that the printing plate 12 of a pattern to be printed is located at the ink applying position. The plate board tray 270 is provided with a holding mechanism for seizing and holding the plate board 11, whereby the plate board 11 is fixed on the plate board tray 270. The tray sending unit 280 is arranged in that the plate board tray 270 is mounted thereon and in that the plate board tray 270 is moved by being slid in a length direction thereof, and through coincidence of a positioning groove provided at the plate board tray 270 and a stopper provided at the tray sending unit 280, either one the four printing plates 12 on the plate board 11 is selected to be fixed at the ink applying position for positioning.

In this state, the person to be treated puts a finger to which nail art is to be performed on the fingertip fixing means 211 of the finger mounting base 210. The fingertip fixing means 211 is substantially similar to that as illustrated in FIG. 3. However, the present embodiment is arranged in that a finger pincher is operated by manually moving a finger pinching handle 212. After fixing the finger, an operation starting switch (not shown) is actuated to start nail art printing operations.

First, the pad back and forth moving unit 230 converts rotations of a back and forth moving motor (not shown) into rotation of a shaft gear so that a pad mounting stage 231 that is movable back and forth upon engagement with the shaft gear and the squeegee unit 250 that is integrally connected with the pad mounting stage 231 are moved rearward (right-hand side direction in FIG. 9). The pad mounting stage 231 is provided with a roller structure, and the position of the pad mounting stage 231 can be detected when the roller structure presses one of three micro-switches, which are provided in alignment at specified positions along back and forth moving directions, ON. When the roller structure switches the backmost micro-switch ON, a rearward position is detected, and at this position, the pad back and forth moving unit 230 terminates the pad mounting stage 231. The rear detecting position corresponds to the ink applying position at which a pad 241 is located just above the selected printing plate 12.

While the squeegee unit 250 moves rearward together with the pad mounting stage 231 during this stage, the squeegee 251 moves on the plate board 11 in a width direction of the plate board 11 during this movement for performing operations of spreading and filling in the preliminarily dropped ink on the printing plate 12 and of simultaneously scraping off excessive ink. With this arrangement, ink is applied to the printing surface 12.

After completion of application of ink, the squeegee unit 250 raises a blade edge of the squeegee 251 for protecting the same and retracts. In the course of this retraction, the blade edge of the squeegee 251 is scraped by a cleaning blade 261 of the squeegee cleaner 260 and is cleaned by chipping off ink that has adhered to the blade edge when ink has been applied onto the plate board 11 or scraped off therefrom. Thereafter, the retraction of the pad mounting stage 231 and the squeegee unit 250 is terminated when the ink applying position is reached.

At this ink applying position, the pad up and down moving unit 240 works to move a up and down moving motor 242 and descends the pad 241 onto the printing plate 12 applied with the ink and continues pressing the same for a specified period of time. With this arrangement, the ink applied on the printing plate 12 is transferred onto the pad 241. Upon completion of transfer of ink to the pad 241, the pad up and down moving unit 240 works to move the up and down moving motor 242 for drawing the pad 241 up. An area of the up and down movement of the pad up and down moving unit 240 is detected by pressing two micro-switches provided in vertical directions through a pressing mechanism of the pad up and down moving unit 240 ON.

When the pad 241 after completion of transfer of ink is drawn up, the pad back and forth moving unit 230 moves the back and forth moving motor to move the mounting stage 231 and the squeegee unit 250 integrally connected thereto frontward (left-hand side direction in FIG. 9). A forward position can be detected when a roller structure provided at the pad mounting stage 231 presses a top one of three micro-switches that are provided in alignment at specified positions ON. This detected position corresponds to a nail art printing position at which the pad 241 is located just above the nail of the finger that is fixed on the fingertip fixing means 211 of the finger mounting base 210, and the pad back and forth moving unit 230 terminates the pad mounting stage 231 at this position.

At this position, the pad up and down moving unit 240 moves a up and down moving motor 242 for descending the pad 241 above the nail of the fixed finger and pressing the same for a specified period of time. With this arrangement, ink transferred onto the pad 241 is retransferred to the nail to perform nail art printing. Upon completion of nail art printing to the nail, the pad up and down moving unit 240 moves the up and down moving motor 242 for repeatedly drawing up the pad 241.

When the pad 241 is drawn up after completion of nail art printing, the pad back and forth moving unit 230 works to move the back and forth moving motor to move the mounting stage 231 and the squeegee unit 250 integrally connected thereto rearward (right-hand side in FIG. 9) to terminate the same at a position at which a roller structure provided at the pad mounting stage 231 has pressed an intermediate one of three micro-switches, which are provided in alignment at specified positions along moving directions, ON. This terminating position corresponds to the pad cleaning position at which the pad 241 is just above the pad cleaner 220. The side view of FIG. 9 illustrates a state at this terminated position.

At this pad cleaning position, the pad up and down moving unit 240 moves the up and down moving motor 242 for descending the pad 241 on an adhesive tape stretched at a tape guide 221 of the pad cleaner 220 for pressing the same onto the adhesive surface for a specified period of time. With this arrangement, foreign matters, dirt and dust adhering on the pad 241 and remaining ink is removed by being adhered to the adhesive surface. A winding lever 222 is provided at a side of the pad cleaner 220 for winding up the tape, and the pad back and forth moving unit 230 contacts and presses this winding lever 222 when it moves from the nail art printing position to the pad cleaning position so that the adhesive tape is send by a constant width, and a new adhesive surface will contact the pad 241.

Upon completion of cleaning of the pad 241, the pad up and down moving unit 240 moves the up and down moving motor 242 for drawing up the pad 241. Through this series of actions, a pattern of a selected printing plate 12 is nail art printed onto a finger of a person to be treated. By repeating nail art printing upon selecting plate boards 11 and printing plates 12, it is possible to print more complicated patterns on the basis of combinations of a plurality of patterns.

Operations of a printing plate washing unit 285 according to this embodiment will now be explained. Upon completion of transfer of ink to the pad 241 at the ink applying position, the printing plate washing unit 285 makes a small amount of water flow onto the printing plate 12 from an upwardly provided tank (not shown) to wet the same, and the wetted printing plate 12 is wiped by a cleaner for cleaning the same. Since the ink is water-soluble, cleaning can be sufficiently performed with a small amount of water, and used water and remaining ink can be completely absorbed by a tissue of the cleaner or cotton.

According to both of the second and third embodiments, all operations are controlled by a sequencer or a microcomputer (not shown), and upon starting operations after initial settings of the plate boards or similar, nail art printing can be performed while requiring almost no manpower.

While the nail art performing device according to the present invention has been explained so far on the basis of embodiments thereof, various forms of the present invention may be considered without departing from the sprit of the present invention. For instance, while selection of a plate board 11 is realized by moving the holder 71 of the plate stocker/changer 7 up and down in the first embodiment, it is also possible to select a plate board 11 and mount the same manually onto the plate feeding mechanism 8 as in the second and third embodiments, and there is no harm in performing selection in another way. Various ways of applying ink to the printing plates 12 and of transferring the plate boards 11 other than those illustrated in the first embodiment may be considered. Further, while the pad 61 and the squeegee 62 are simultaneously moved by the pad/squeegee unit 6 in the first embodiment, there is of course no harm in moving them by separate feeding means. While the ink was water-soluble in the above embodiments, there is no harm in employing other types such as oil-based ink. However, when employing oil-based ink, it might become necessary to take special care of the squeegees 62, 110, 251 or the printing plate washing unit 3 to correspond to such ink.

As explained so far, the nail art performing device of the present invention performs nail art printing by selecting one of a plurality of inks, dropping the selected ink in vicinity of a selected printing plate on a plate board, spreading and applying the dropped ink on concave portions of the printing plate for once transferring the applied ink to a pad whereupon the ink is retransferred to a nail of a person to be treated. With this arrangement, it is possible to realize a nail art performing device capable of performing printing of nail art on a nail of a user in a relatively short period of time upon selection of desired ones from among various patterns of a plurality of printing plates and various colors, that may be easily operated, that creates little noise and stains on operation surfaces when performing printing, and with which a person to be treated can enjoy nail art without troublesome feelings. The device illustrated in the second and third embodiments is particularly advantaged in that it is of small-size and lightweight, easy to operate, ready to respond to demands of persons to be treated, and easy to clean.

1. A nail art performing device for applying ink onto a printing plate formed with concave portions, transferring the ink present on the concave portions of the printing plate onto a pad, and retransferring the ink that has been transferred onto the pad onto a nail, the nail art performing device comprising:
a fingertip fixing means that fixes a fingertip of a person to be treated,
a printing plate selecting means that selects a printing plate to be used from among a plurality of those printing plates,
a printing plate transferring means that transfers a printing plate that has been selected by the printing plate selecting means on an operation plane,
an ink dropping means that selects one of those inks introduced from a plurality of ink containers accumulating therein the inks and dropping the selected ink in vicinity of the printing plate being transferred by the printing plate transferring means,
an ink applying means that applies the ink that has been dropped in vicinity of the printing plate by the ink dropping means onto the printing plate, and
a printing means that, after transfer of the ink applied onto the printing plate by the ink applying means to the pad, makes the pad contact a nail of the fingertip of the person to be treated that is fixed by the fingertip fixing means for retransfer and to thereby perform printing on the nail.

2. The nail art performing device as claimed in claim 1, wherein the fingertip fixing means is provided with a nail position designating means that determines a position of the nail of the person to be treated.

3. The nail art performing device as claimed in claim 1, wherein the printing plate transferring means moves the printing plate that has been selected by the printing plate selecting means on the operation plane in a linear manner, wherein a printing plate receiving position at which the printing plate transferring means receives the printing plate, an ink drop operation position at which the ink is dropped onto the printing plate, a transfer operation position at which the dropped ink is applied onto the printing plate and the applied ink is transferred onto the pad, a printing plate washing position at which the printing plate is washed after completion of the transfer operation, and a printing plate drying position at which the washed printing plate is dried are aligned on the operation plane in this order, and wherein the printing plate transferring means transfers the printing plate in this order between the respective positions.

4. The nail art performing device as claimed in claim 1, further comprising
a medium mounting means capable of mounting a plurality of printing plate-bearing media, which are media formed with at least one of the printing plates, and
a medium pick-up means that picks up one of the printing plate-bearing media mounted on the medium mounting means,
wherein the printing plate transferring means transfers the printing plate-bearing medium that has been picked up by the medium pick-up means and wherein the ink dropping means drops one of those inks selected and introduced from the ink containers in vicinity of the printing plate being transferred by the printing plate transferring means.

5. The nail art performing device as claimed in claim 4, wherein when the medium pick-means has picked up the printing plate-bearing medium formed with a plurality of printing plates, printing to the nail is repeatedly performed while changing the printing plates of the picked up printing plate-bearing medium that are used for printing as needed.

6. The nail art performing device as claimed in claim 4, wherein the ink that has been dropped by the ink dropping means with respect to the printing plate-bearing medium that is transferred by the printing plate transferring means is applied by a squeegee that comprises the ink applying means.

7. The nail art performing device as claimed in claim 1, further comprising a pad washing means for washing the pad.

8. The nail art performing device as claimed in claim 1, further comprising a printing plate washing means for washing the printing plate.

9. A nail art performing device for applying ink onto a printing plate formed with concave portions, transferring the ink present on the concave portions of the printing plate onto a pad, and retransferring the ink that has been transferred onto the pad onto a nail, the nail art performing device comprising:
a fingertip fixing means that fixes a fingertip of a person to be treated,
an ink applying means that applies the ink that has been dropped in vicinity of the printing plate by the ink dropping means,
a pad cleaning means that cleans the pad,
a pad moving means that moves the pad among respective operation positions on the ink applying means, on the pad cleaning means and on the fingertip fixing means,
a pad elevating means that moves the pad up and down, that transfers ink to the pad on the ink applying means, that retransfers ink that has been transferred to the pad upon making it contact a nail of the fingertip of the person to be treated that is fixed or the fingertip fixing means, and that cleans residing ink or foreign matters adhering to the pad on the pad cleaning means.

10. The nail art performing device as claimed in claim 9, wherein the fingertip fixing means is provided with a nail position designating means that determines a position of the nail of the person to be treated.

11. The nail art performing device as claimed in claim 9, wherein the operation positions are located on a circumference, and wherein the pad moving means moves the pad on this circumference.

12. The nail art performing device as claimed in claim 9, wherein the operation positions are located on a straight line, and wherein the pad moving means moves the pad on this straight line.

13. The nail art performing device as claimed in claim 9, further comprising a printing plate washing means for washing the printing plate.

14. The nail art performing device as claimed in claim 13, wherein the printing plate washing means includes a washing liquid absorbing means that absorbs washing liquid with which the printing plate has been washed.

15. The nail art performing device as claimed in claim 2, wherein the printing plate transferring means moves the printing plate that has been selected by the printing plate selecting means on the operation plane in a linear manner, wherein a printing plate receiving position at which the printing plate transferring means receives the printing plate, an ink drop operation position at which the ink is dropped onto the printing plate, a transfer operation position at which the dropped ink is applied onto the printing plate and the applied ink is transferred onto the pad, a printing plate washing position at which the printing plate is washed after completion of the transfer operation, and a printing plate drying position at which the washed printing plate is dried are aligned on the operation plane in this order, and wherein the printing plate transferring means transfers the printing plate in this order between the respective positions.

16. The nail art performing device as claimed in claim 2, further comprising
a medium mounting means capable of mounting a plurality of printing plate-bearing media, which are media formed with at least one of the printing plates, and
a medium pick-up means that picks up one of the printing plate-bearing media mounted on the medium mounting means,
wherein the printing plate transferring means transfers the printing plate-bearing medium that has been picked up by the medium pick-up means and wherein the ink dropping means drops one of those inks selected and introduced from the ink containers in vicinity of the printing plate being transferred by the printing plate transferring means.

17. The nail art performing device as claimed in claim 3, further comprising
a medium mounting means capable of mounting a plurality of printing plate-bearing media, which are media formed with at least one of the printing plates, and
a medium pick-up means that picks up one of the printing plate-bearing media mounted on the medium mounting means,
wherein the printing plate transferring means transfers the printing plate-bearing medium that has been picked up by the medium pick-up means and wherein the ink dropping means drops one of those inks selected and introduced from the ink containers in vicinity of the printing plate being transferred by the printing plate transferring means.

18. The nail art performing device as claimed in claim 5, wherein the ink that has been dropped by the ink dropping means with respect to the printing plate-bearing medium that is transferred by the printing plate transferring means is applied by a squeegee that comprises the ink applying means.

19. The nail art performing device as claimed in claim 2, further comprising a pad washing means for washing the pad.

20. The nail art performing device as claimed in claim 3, further comprising a pad washing means for washing the pad.

21. The nail art performing device as claimed in claim 4, further comprising a pad washing means for washing the pad.

22. The nail art performing device as claimed in claim 5, further comprising a pad washing means for washing the pad.

23. The nail art performing device as claimed in claim 6, further comprising a pad washing means for washing the pad.

24. The nail art performing device as claimed in claim 2, further comprising a printing plate washing means for washing the printing plate.

25. The nail art performing device as claimed in claim 3, further comprising a printing plate washing means for washing the printing plate.

26. The nail art performing device as claimed in claim 4, further comprising a printing plate washing means for washing the printing plate.

27. The nail art performing device as claimed in claim 5, further comprising a printing plate washing means for washing the printing plate.

28. The nail art performing device as claimed in claim 6, further comprising a printing plate washing means for washing the printing plate.

29. The nail art performing device as claimed in claim 7, further comprising a printing plate washing means for washing the printing plate.

30. The nail art performing device as claimed in claim 10, wherein the operation positions are located on a circumference, and wherein the pad moving means moves the pad on this circumference.

31. The nail art performing device as claimed in claim 10, wherein the operation positions are located on a straight line, and wherein the pad moving means moves the pad on this straight line.

32. The nail art performing device as claimed in claim 10, further comprising a printing plate washing means for washing the printing plate.

33. The nail art performing device as claimed in claim 11, further comprising a printing plate washing means for washing the printing plate.

34. The nail art performing device as claimed in claim 12, further comprising a printing plate washing means for washing the printing plate.
